(19) United States
(12) Patent Application Publication
(10) Pub. No.: US 2023/0277878 A1
(43) Pub. Date: Sep. 7, 2023

(54) Face Masking Device

(71) Applicant: Komet Koffi, Garland, TX (US)

(72) Inventor: Komet Koffi, Garland, TX (US)

(21) Appl. No.: 17/683,729

(22) Filed: Mar. 1, 2022

(51) Int. Cl. A62B 23/02; A41D 13/11

(52) U.S. Cl. CPC A62B 23/02; A41D 13/11

(57) ABSTRACT

A face masking device for filtering air and facilitating communication includes a frame and a panel. The frame comprises a bridge, a pair of bars, and a pair of temples and resembles a modified eyeglass frame. Each bar extends arcuately from a respective opposed end of the bridge so that the bar is positioned below an associated eye of a user when the bridge is positioned on a nose of the user. Each temple is engaged to and extends substantially perpendicularly from a respective bar distal from the bridge. The temple engages a respective ear of the user to engage the frame to a head of the user. The panel is engaged to and extends from the bridge and the bars so that the panel is positioned over a nose and mouth of the user. The panel is air permeable and thus filters particulates from air during inhalation and exhalation.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to personal protective devices and more particularly pertains to a new personal protective device for filtering air and facilitating communication. The present invention discloses a personal protective device comprising a modified eyeglass frame supporting a facemask over a user’s nose and mouth.

### Description of Related Art Including Information Disclosed Under 37 CFR 1.97 and 1.98.

The prior art relates to personal protective devices. Prior art personal protective devices may comprise face shields having temples and surgical masks with integrated communication modules. Related prior art comprises respirators with integrated communication modules. What is lacking in the prior art is a face masking device comprising a modified eyeglass frame supporting a facemask over a user’s nose and mouth. Further lacking in the prior art is a communications module engaged to the modified eyeglass frame that interfaces with an electronic device of the user.

### (H) BRIEF SUMMARY OF THE INVENTION

An embodiment of the disclosure meets the needs presented above by generally comprising a frame and a panel. The frame comprises a bridge, a pair of bars, and a pair of temples and resembles a modified eyeglass frame. Each bar extends arcuately from a respective opposed end of the bridge so that the bar is positioned below an associated eye of a user when the bridge is positioned on a nose of the user. Each temple is engaged to and extends substantially perpendicularly from a respective bar distal from the bridge. The temple is configured to engage a respective ear of the user to engage the frame to a head of the user. The panel is engaged to and extends from the bridge and the bars so that the panel is positioned over a nose and mouth of the user. The panel is air permeable and thus is configured to filter particulates from air during inhalation and exhalation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a front isometric perspective view of a face masking device according to an embodiment of the disclosure.

FIG. 2 is a rear isometric perspective view of an embodiment of the disclosure.

FIG. 3 is a front view of an embodiment of the disclosure.

FIG. 4 is a side view of an embodiment of the disclosure.

FIG. 5 is a top view of an embodiment of the disclosure.

FIG. 6 is a detail view of an embodiment of the disclosure.

FIG. 7 is a detail view of an embodiment of the disclosure.

### (J) DETAILED DESCRIPTION OF THE INVENTION

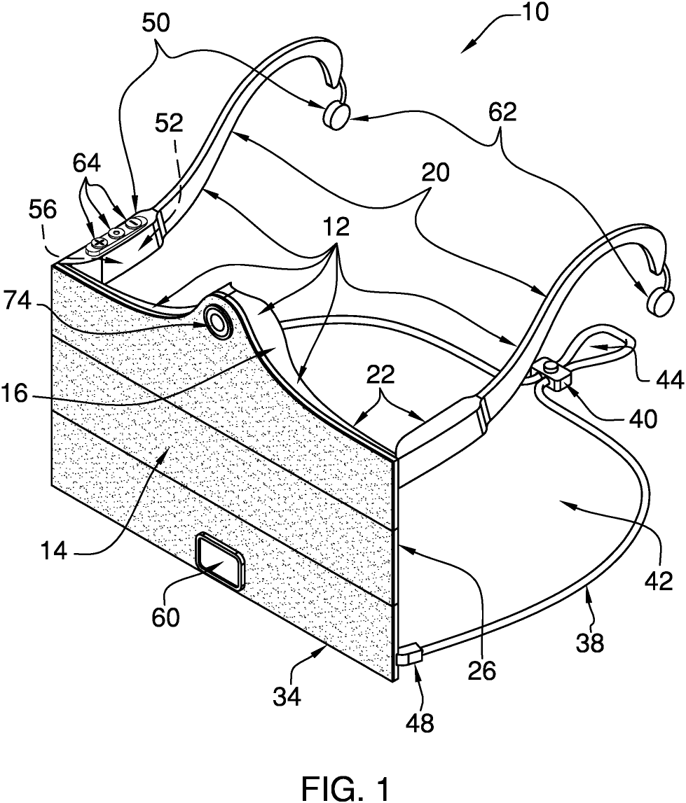

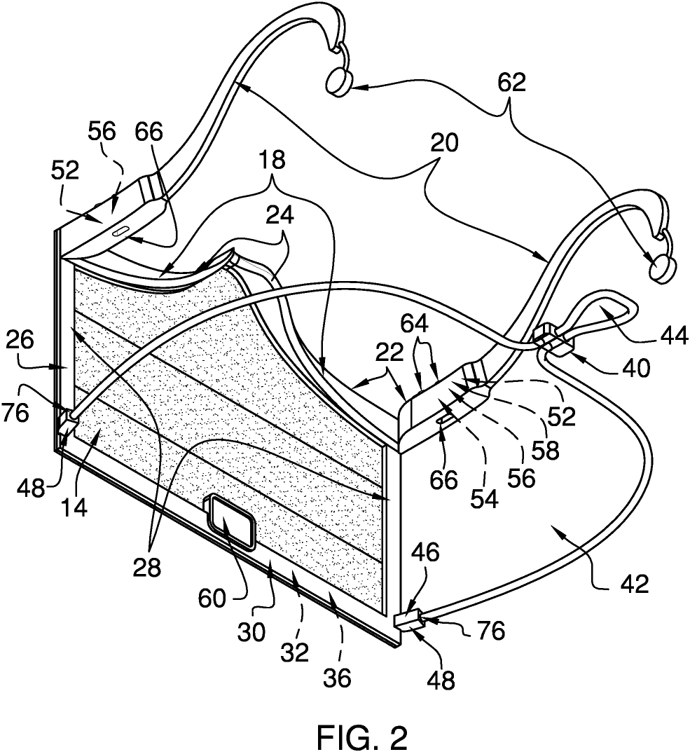

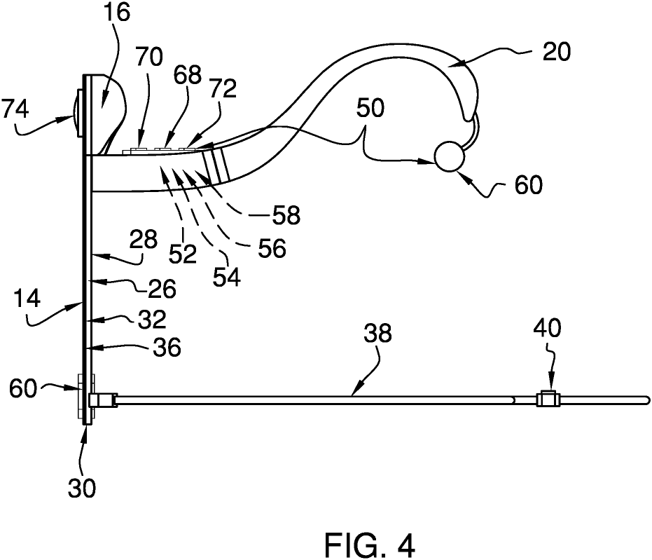

With reference now to the drawings, and in particular to FIGS. 1 through 7 thereof, a new personal protective device embodying the principles and concepts of an embodiment of the disclosure and generally designated by the reference numeral 10 will be described.

As best illustrated in FIGS. 1 through 7, the face masking device 10 generally comprises a frame 12 and a panel 14. The frame 12 comprises a bridge 16, a pair of bars 18, and a pair of temples 20 and resembles a modified eyeglass frame 22. Each bar 18 extends arcuately from a respective opposed end 24 of the bridge 16 so that the bar 18 is positioned below an associated eye of a user when the bridge 16 is positioned on a nose of the user. Each temple 20 is engaged to and extends substantially perpendicularly from a respective bar 18 distal from the bridge 16. The temple 20 is configured to engage a respective ear of the user to engage the frame 12 to a head of the user. The temple 20 may be arcuate distal from the respective bar 18 and thus configured to hook over the respective ear of the user. The present invention also anticipates the temple 20 being hingedly engaged to the respective bar 18.

The panel 14 is engaged to and extends from the bridge 16 and the bars 18 so that the panel 14 is positioned over a nose and mouth of the user. The panel 14 is air permeable and thus is configured to filter particulates from air during inhalation and exhalation. The panel 14 comprises one or more of cloth, gauze, cellulose, polypropylene, and the like. The present invention is anticipated to be useful in filtering particulates from air breathed by a user, such as dust, bacteria, and viruses. Additionally, the panel 14 provides protection to the user and to persons proximate to the user by stopping aerosols and droplets, which can contain bacteria and viruses.

A framework 26 is engaged to and extends from the frame 12. The framework 26 comprises a pair of side members 28 and a bottom member 30. Each side member 28 is engaged to and extends substantially perpendicularly from a respective bar 18 distal from the bridge 16 so that the side members 28 bracket the nose and the mouth of the user. The bottom member 30 is engaged to and extends between the side members 28 distal from the bars 18 so that the bottom member 30 is positioned below a chin of the user. The panel 14 is engaged to and extends between the frame 12 and the framework 26 so that the panel 14 covers the nose and mouth of the user. The framework 26, the bridge 16, and the bars 18 may be resiliently flexible and thus configured to conform to contours of a face of the user.

The panel 14 may be removably engageable to the frame 12 and the framework 26 so that the panel 14 is removable for cleaning and replacement. A first fastener 32 is engaged to the panel 14 and extends around a circumference 34 of the panel 14. A second fastener 36 is engaged to the bridge 16, the arms, and the framework 26. The second fastener 36 is complementary to the first fastener 32 so that the second fastener 36 is positioned to selectively engage the first fastener 32 to removably engage the panel 14 to the frame 12 and the framework 26. The first fastener 32 and the second fastener 36 may comprise a hook and loop fastener, pressure sensitive adhesive, and the like. The present invention also anticipates the panel 14 being slidably engaged to the frame 12 and the framework 26 so that is can be selectively slid toward a respective side member 28.

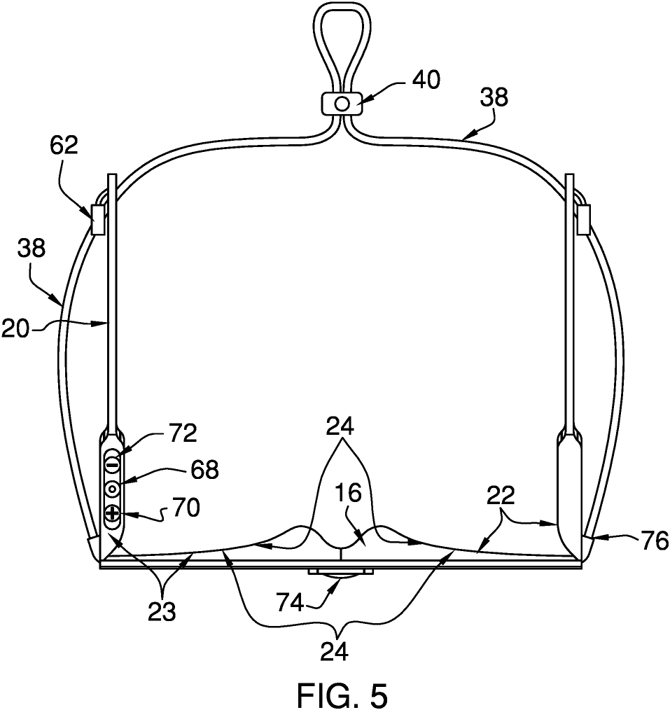

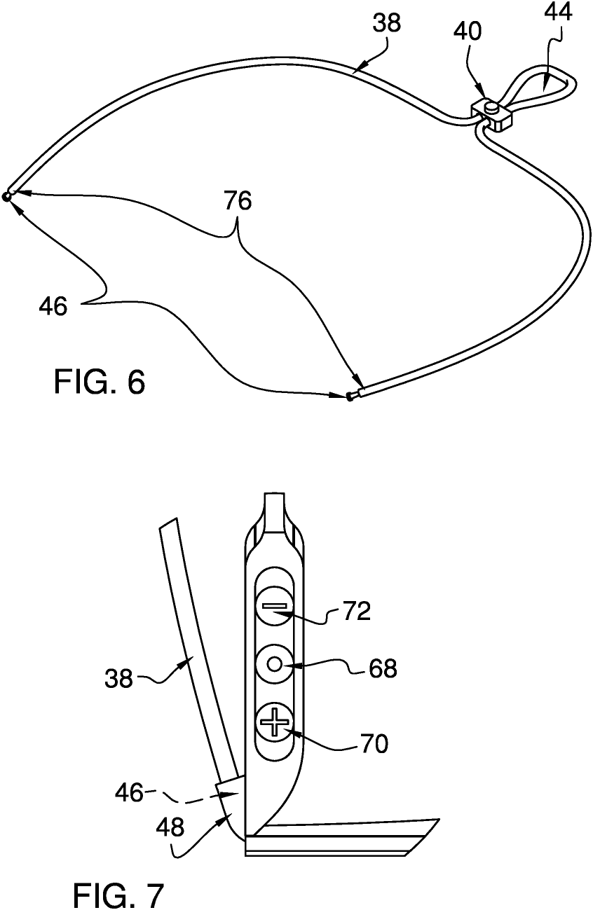

A strap 38 is engaged to and extends between the side members 28 distal from the bars 18. The strap 38 is configured to be positioned around a neck of the user to removably engage the framework 26 to the user. A cord lock 40 is engaged to the strap 38 and defines a primary loop 42 and a secondary loop 44, as shown in FIG. 5. The cord lock 40 is slidably engaged to the strap 38 so that the primary loop 42 is selectively size adjustable. Adjusting the primary loop 42 to fit a neck of the user helps to seal the framework 26 to the face of the user. A pair of first connectors 46 is engaged singly to opposing termini 76 of the strap 38, as shown in FIG. 6. A pair of second connectors 48 is engaged to the framework 26. The second connectors 48 are complementary to the first connectors 46 so that each second connector 48 is positioned to selectively engage a respective first connector 46 to removably engage the strap 38 to the framework 26.

A communications module 50 is engaged to the frame 12 and the framework 26. The communications module 50 is configured to wirelessly engage an electronic device, such as a smartphone of the user, so that two-way communication between the communications module 50 and the electronic device is enabled.

The communications module 50 comprises a void 52, which is positioned in a respective temple 20. A microprocessor 54, a battery 56, and a transceiver 58 are positioned in the void 52. The microprocessor 54 is operationally engaged to the battery 56 and the transceiver 58. A microphone 60 is engaged to the bottom member 30 substantially equally distant from the side members 28 so that the microphone 60 is positioned proximate to the mouth of the user. Each of a pair of earbuds 62 is tethered to and extends from a respective temple 20. The earbud 62 is configured to engage an associated ear of the user.

A controller 64 is engaged to the respective temple 20. The microphone 60, the earbuds 62, and the controller 64 are operationally engaged to the microprocessor 54. The controller 64 is configured for input of commands into the microprocessor 54 to actuate the transceiver 58 and to adjust a volume of the earbuds 62.

The battery 56 is rechargeable. A port 66 is engaged to the respective temple 20 and is operationally engaged to the battery 56. The port 66 is configured for insertion of a plug of a charging cord (not shown) to charge the battery 56. The present invention also anticipates batteries 56 being positioned in each temple 20, with each battery 56 being chargeable by a respective port 66 of a pair of ports 66.

The controller 64 comprises a power button 68, a first button 70, and a second button 72, which are depressible. The power button 68 is configured to be depressed to operationally engage the microprocessor 54 to the battery 56 and to signal the microprocessor 54 to signal the transceiver 58 to pair with the electronic device. The first button 70 is configured to be depressed to signal the microprocessor 54 to increase a volume of the earbuds 62. The second button 72 is configured to be depressed to signal the microprocessor 54 to decrease a volume of the earbuds 62.

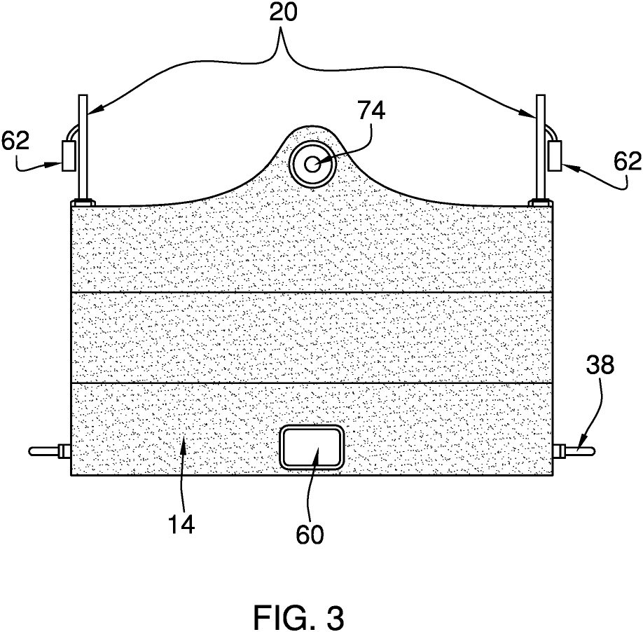

The face masking device 10 also may comprise a camera 74, which is engaged to the frame 12 and which is operationally engaged to the microprocessor 54. The camera 74 is configured to capture an image of an area proximate to the user. The camera 74 may be engaged to the bridge 16, as shown in FIG. 3.

In use, the bridge 16 is positioned on the nose of the user with the temples 20 engaging the ears of the user. The panel 14 thus is positioned over the nose and the mouth of the user. The panel 14 filters particulates from air during inhalation and exhalation. The communications module 50 enables communication with the smartphone of the user, thus allowing the user to communicate via the smartphone while wearing the face masking device 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A face masking device comprising:
a frame comprising:
a bridge, and
a pair of bars, each bar extending arcuately from a respective opposed end of the bridge, such that the bar is positioned below an associated eye of a user when the bridge is positioned on a nose of the user, and
a pair of temples, each temple being engaged to and extending substantially perpendicularly from a respective bar distal from the bridge, wherein the temple is configured for engaging a respective ear of the user for engaging the frame to a head of the user; and
a panel engaged to and extending from the bridge and the bars, such that the panel is positioned over a nose and mouth of the user, the panel being air permeable, wherein the panel is configured for filtering particulates from air during inhalation and exhalation.

2. The face masking device of claim 1, wherein the temple is arcuate distal from the respective bar, wherein the temple is configured for hooking over the respective ear of the user.

3. The face masking device of claim 1, wherein the panel comprises one or more of cloth, gauze, cellulose, and polypropylene.

4. The face masking device of claim 1, further including a framework engaged to and extending from the frame, the framework comprising:
a pair of side members, each side member being engaged to and extending substantially perpendicularly from a respective bar distal from the bridge, such that the side members bracket the nose and the mouth of the user; and
a bottom member engaged to and extending between the side members distal from the bars, such that the bottom member is positioned below a chin of the user, the panel being engaged to and extending between the frame and the framework, such that the panel covers the nose and mouth of the user.

5. The face masking device of claim 4, wherein the framework, the bridge, and the bars are resiliently flexible, wherein the framework, the bridge, and the bars are configured for conforming to contours of a face of the user.

6. The face masking device of claim 4, wherein the panel is removably engageable to the frame and the framework, such that the panel is removable for cleaning and replacement.

7. The face masking device of claim 6, further including:
a first fastener engaged to the panel and extending around a circumference of the panel; and
a second fastener engaged to the bridge, the arms, and the framework, the second fastener being complementary to the first fastener, such that the second fastener is positioned for selectively engaging the first fastener for removably engaging the panel to the frame and the framework.

8. The face masking device of claim 4, further including a strap engaged to and extending between the side members distal from the bars, wherein the strap is configured for positioning around a neck of the user for removably engaging the framework to the user.

9. The face masking device of claim 8, further including a cord lock engaged to the strap defining a primary loop and a secondary loop, the cord lock being slidably engaged to the strap, such that the primary loop is selectively size adjustable.

10. The face masking device of claim 8, further including:
a pair of first connectors engaged singly to opposing termini of the strap; and
a pair of second connectors engaged to the framework, the second connectors being complementary to the first connectors, such that each second connector is positioned for selectively engaging a respective first connector for removably engaging the strap to the framework.

11. The face masking device of claim 4, further including a communications module engaged to the frame and the framework, the communications module being configured for wirelessly engaging an electronic device of the user, such that two-way communication between the communications module and the electronic device is enabled.

12. The face masking device of claim 11, wherein the communications module comprises:
a void positioned in a respective temple;
a microprocessor, a battery, and a transceiver positioned in the void, the microprocessor being operationally engaged to the battery and the transceiver;
a microphone engaged to the bottom member substantially equally distant from the side members, such that the microphone is positioned proximate to the mouth of the user, the microphone being operationally engaged to the microprocessor;
a pair of earbuds, each earbud being tethered to and extending from a respective temple, such that the earbud is configured for engaging an associated ear of the user, the earbuds being operationally engaged to the microprocessor; and
a controller engaged to the respective temple and being operationally engaged to the microprocessor, wherein the controller is configured for inputting of commands into the microprocessor for actuating the transceiver and for adjusting a volume of the earbuds.

13. The face masking device of claim 12, further including:
the battery being rechargeable; and
a port engaged to the respective temple and being operationally engaged to the battery, wherein the port is configured for insertion of a plug of a charging cord for charging the battery.

14. The face masking device of claim 12, wherein the controller comprises:
a power button, the power button being depressible, wherein the power button is configured for depressing for operationally engaging the microprocessor to the battery and for signaling the microprocessor for signaling the transceiver for pairing with the electronic device;
a first button, the first button being depressible, wherein the first button is configured for depressing for signaling the microprocessor for increasing a volume of the earbuds; and
a second button, the second button being depressible, wherein the second button is configured for depressing for signaling the microprocessor for decreasing a volume of the earbuds.

15. The face masking device of claim 12, further including a camera engaged to the frame and being operationally engaged to the microprocessor, wherein the camera is configured for capturing an image of an area proximate to the user.

16. The face masking device of claim 15, wherein the camera is engaged to the bridge.

17. A face masking device comprising:
a frame comprising:
a bridge,
a pair of bars, each bar extending arcuately from a respective opposed end of the bridge, such that the bar is positioned below an associated eye of a user when the bridge is positioned on a nose of the user, the bridge and the bars being resiliently flexible, wherein the bridge and the bars are configured for conforming to contours of a face of the user, and
a pair of temples, each temple being engaged to and extending substantially perpendicularly from a respective bar distal from the bridge, wherein the temple is configured for engaging a respective ear of the user for engaging the frame to a head of the user, the temple being arcuate distal from the respective bar, wherein the temple is configured for hooking over the respective ear of the user;
a panel engaged to and extending from the bridge and the bars, such that the panel is positioned over a nose and mouth of the user, the panel being air permeable, wherein the panel is configured for filtering particulates from air during inhalation and exhalation, the panel comprising one or more of cloth, gauze, cellulose, and polypropylene;
a framework engaged to and extending from the frame, the framework comprising:
a pair of side members, each side member being engaged to and extending substantially perpendicularly from a respective bar distal from the bridge, such that the side members bracket the nose and the mouth of the user, and
a bottom member engaged to and extending between the side members distal from the bars, such that the bottom member is positioned below a chin of the user, the panel being engaged to and extending between the frame and the framework, such that the panel covers the nose and mouth of the user, the panel being removably engageable to the frame and the framework, such that the panel is removable for cleaning and replacement, the framework being resiliently flexible, wherein the framework is configured for conforming to contours of the face of the user;
a first fastener engaged to the panel and extending around a circumference of the panel;
a second fastener engaged to the bridge, the arms, and the framework, the second fastener being complementary to the first fastener, such that the second fastener is positioned for selectively engaging the first fastener for removably engaging the panel to the frame and the framework;
a strap engaged to and extending between the side members distal from the bars, wherein the strap is configured for positioning around a neck of the user for removably engaging the framework to the user;
a cord lock engaged to the strap defining a primary loop and a secondary loop, the cord lock being slidably engaged to the strap, such that the primary loop is selectively size adjustable;
a pair of first connectors engaged singly to opposing termini of the strap;
a pair of second connectors engaged to the framework, the second connectors being complementary to the first connectors, such that each second connector is positioned for selectively engaging a respective first connector for removably engaging the strap to the framework; and
a communications module engaged to the frame and the framework, the communications module being configured for wirelessly engaging an electronic device of the user, such that two-way communication between the communications module and the electronic device is enabled, the communications module comprising:
a void positioned in a respective temple,
a microprocessor, a battery, and a transceiver positioned in the void, the microprocessor being operationally engaged to the battery and the transceiver, the battery being rechargeable,
a port engaged to the respective temple and being operationally engaged to the battery, wherein the port is configured for insertion of a plug of a charging cord for charging the battery,
a microphone engaged to the bottom member substantially equally distant from the side members, such that the microphone is positioned proximate to the mouth of the user, the microphone being operationally engaged to the microprocessor,
a pair of earbuds, each earbud being tethered to and extending from a respective temple, such that the earbud is configured for engaging an associated ear of the user, the earbuds being operationally engaged to the microprocessor, and
a controller engaged to the respective temple and being operationally engaged to the microprocessor, wherein the controller is configured for inputting of commands into the microprocessor for actuating the transceiver and for adjusting a volume of the earbuds, the controller comprising:
a power button, the power button being depressible, wherein the power button is configured for depressing for operationally engaging the microprocessor to the battery and for signaling the microprocessor for signaling the transceiver for pairing with the electronic device,
a first button, the first button being depressible, wherein the first button is configured for depressing for signaling the microprocessor for increasing a volume of the earbuds, and
a second button, the second button being depressible, wherein the second button is configured for depressing for signaling the microprocessor for decreasing a volume of the earbuds.

18. The face masking device of claim 17, further including a camera engaged to the frame and being operationally engaged to the microprocessor, wherein the camera is configured for capturing an image of an area proximate to the user, the camera being engaged to the bridge.
